(19) United States
(12) Patent Application Publication
(10) Pub. No.: US 2026/0271005 A1
(43) Pub. Date: Sep. 10, 2026

(54) Methods And Apparatus For Receiving System Information In A Connected Mode In Mobile Communications

(71) Applicant: MediaTek Inc., Hsinchu City (TW)

(72) Inventors: Jen-Chien Liu, Hsinchu City (TW); Antti Olavi Kaisto, Oulu (FI); Markus Sakari Niemela, Oulu (FI); Antti Olavi Kangas, Oulu (FI); Pasi Petteri Laitinen, Oulu (FI); Chun-Fan Tsai, Hsinchu City (TW)

(73) Assignee: MediaTek Inc., Hsinchu City (TW)

(21) Appl. No.: 19/466,288

(22) Filed: Jan. 31, 2026

Related U.S. Application Data
(60) Provisional application No. 63/762,694, filed on Feb. 25, 2025.

(51) Int. Cl. H04W 72/21; H04W 36/00

(52) U.S. Cl. CPC H04W 72/21; H04W 36/0055

(57) ABSTRACT

Various solutions for system information reception in a connected mode in mobile communications are described. The user equipment (UE) may determine at least one required system information block (SIB) in an event that the apparatus is in a connected mode. The UE may transmit the uplink message including a list of the at least one required SIB to a network node. The UE may receive the at least one required SIB via a dedicated signaling from the network node in response to the uplink message.

### CROSS REFERENCE TO RELATED PATENT APPLICATION(S)

The present disclosure is part of a non-provisional application claiming the priority benefit of U.S. Patent Application No. 63/762,694, filed 25 Feb. 2025, the content of which herein being incorporated by reference in its entirety.

### TECHNICAL FIELD

The present disclosure is generally related to mobile communications and, more particularly, to system information reception in a connected mode in mobile communications.

### BACKGROUND

Unless otherwise indicated herein, approaches described in this section are not prior art to the claims listed below and are not admitted as prior art by inclusion in this section.

Modern wireless communication systems, including 4G LTE, 5G NR, and evolving 6G systems, are designed to provide seamless mobility and continuous data services to user equipment (UE) while the UE moves across different radio cells. These systems employ a layered radio protocol architecture, in which the Radio Resource Control (RRC) layer is responsible for connection management, mobility control, and the delivery of system information required for radio operation.

In such systems, system information (SI) is used to provide cell-specific information and radio-configuration information to the UE. System information typically includes multiple System Information Blocks (SIBs), such as SIB1, SIB2, and additional SIBs, each serving different purposes. For example, SIB1 mainly provides basic cell access information and scheduling information for other SIBs, while other SIBs may include random access parameters, uplink power control configuration, mobility parameters, and neighbor cell information. System information may be delivered to the UE through broadcast channels, such as the downlink shared channel (DL-SCH), or through dedicated RRC signaling when the UE is in a connected mode.

To maintain service continuity, the wireless network performs a handover procedure when the UE moves from a source cell to a target cell. During handover, the network may transmit a dedicated RRC reconfiguration message, such as an RRCConnectionReconfiguration in LTE or an RRCReconfiguration in NR, to configure mobility parameters and, optionally, to provide certain system information related to the target cell.

However, in practical deployments, the network does not have complete knowledge of which specific system information is required by the UE. The network cannot fully observe or control the UE’s internal behavior, such as uplink access attempts, measurement activities, power control adjustments, or preparation for state transitions. As a result, the network may include insufficient system information or, conversely, excessive system information in the dedicated RRC message. Therefore, even after a successful handover, the UE may determine that certain required system information has not been provided. In such cases, the UE must acquire the missing system information from broadcast channels, following the scheduling information indicated by SIB1.

For example, consider a UE that is actively transmitting uplink data in a source cell and relies on uplink power control and random access configuration parameters provided by system information such as SIB2. During a handover to a target cell, the network transmits a dedicated RRC reconfiguration message that includes mobility control information and basic connection parameters but omits the full set of uplink-related system information. After completing the handover, the UE attempts to initiate an uplink procedure in the target cell and determines that the required system information (e.g., PRACH configuration or uplink power control parameters) is not available in the dedicated signaling. As a result, the UE must suspend or delay the uplink operation and switch to monitoring the broadcast channel to acquire the relevant SIBs transmitted on the DL-SCH.

This additional system information acquisition introduces latency and temporary data interruption, as the UE must switch to the DL-SCH and wait for the appropriate system information window before resuming normal operation. Such interruptions may degrade user experience for latency-sensitive services. Moreover, excessive system information provision by the network may also increase signaling overhead.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to system information reception in a connected mode in mobile communications.

In one aspect, a method may involve an apparatus determining at least one required system information block (SIB) in an event that the apparatus is in a connected mode. The method may also involve the apparatus including a list of the at least one required SIB in an uplink message. The method may further involve transmitting the uplink message to a network node. The method may further involve receiving the at least one required SIB via a dedicated signaling from the network node in response to the uplink message.

In another aspect, a method may involve a network node receiving an uplink message from an apparatus. The uplink message comprises a list of required system information block (SIB). The method may also involve the network node determining at least one required SIB based on the list provided in the uplink message. The method may further involve the network node transmitting the at least one required SIB via a dedicated signaling to the apparatus.

In yet another aspect, an apparatus may include a transceiver which, during operation, wirelessly communicates with a network node of a wireless network. The apparatus may also include a processor communicatively coupled to the transceiver. The processor, during operation, may perform operations comprising determining at least one required system information block (SIB) in an event that the apparatus is in connected mode. The processor, during operation, may also perform operations comprising including a list of the at least one required SIB in an uplink message. The processor, during operation, may also perform operations comprising transmitting, via the transceiver, the uplink message to a network node. The processor, during operation, may further perform operations comprising receiving, via the transceiver, the at least one required SIB via a dedicated signaling from the network node in response to the uplink message.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 illustrates an example scenario 100 of a communication environment in which various solutions and schemes in accordance with the present disclosure may be implemented.

FIG. 2A to 2D are diagrams depicting example scenarios under schemes in accordance with implementations of the present disclosure.

FIG. 3 illustrates an example communication system 300 having an example communication apparatus 310 and an example network apparatus 320 in accordance with an implementation of the present disclosure.

FIG. 4 is an example process 400 in accordance with an implementation of the present disclosure.

FIG. 5 is an example process 500 in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to system information reception in a connected mode in mobile communications. According to the present disclosure, a number of possible solutions may be implemented separately or jointly. That is, although these possible solutions may be described below separately, two or more of these possible solutions may be implemented in one combination or another.

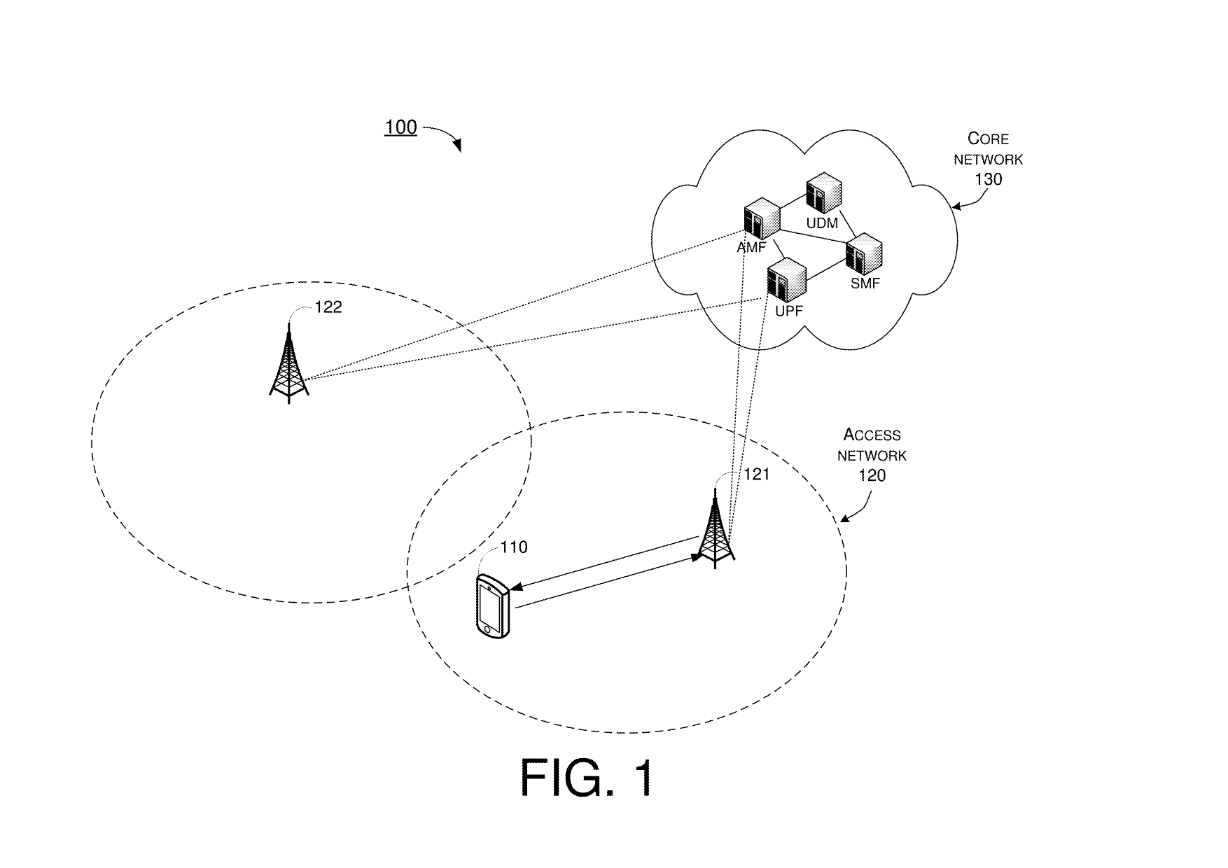

FIG. 1 illustrates an example scenario 100 of a communication environment in which various solutions and schemes in accordance with the present disclosure may be implemented. Scenario 100 involves a UE 110 in wireless communication with a wireless communication network (e.g., an LTE network, a 5G/NR network, an IoT network, or a 6G network) consisting of an access network 120 and a core network 130. The UE 110 may be a smart phone, a wearable device, an IoT device, a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface, more specifically to a user plane function (UPF) by means of the NG user-plane part (NG-u), and to an access and mobility management function (AMF) by means of the NG control-plane part (NG-c). The access network 120 may include a base station (BS) 121, which may be connected to multiple UPFs/AMFs for the purpose of load sharing and redundancy. In addition, the core network may include other entities, such as a session management function (SMF) and a unified data management (UDM), etc. In some embodiments, the access network 120 may include multiple BSs, such as BS 122, each of which may provide communication coverage for a geographic coverage area where communications with the UE 110 are supported.

In scenario 100, a scheme for receiving system information in a connected mode by incorporating UE 110 configured to receive system information via dedicated signaling within the wireless communication network is provided. The BS 121 may transmit a handover command to the UE 110, indicating a handover to the BS 122 and instructing the UE 110 to acquire the system information blocks. In conventional systems, the UE 110 may receive insufficient SIBs, resulting in an interruption of the ongoing service currently being executed, and therefore, the UE 110 needs to additionally obtain the required SIBs from broadcast signaling through a downlink shared channel (DL-SCH). To address this issue, the UE 110 may determine at least one required system information block (SIB) in a connected mode and include a list of the at least one required SIB in an uplink message. The list may comprise one or more required SIBs. Upon including the list of the at least one required SIB in the uplink message, the UE 110 may transmit the uplink message to the BS 122. The BS 122 may transmit the at least one required SIB via a dedicated signaling in response to the uplink message. Consequently, the UE 110 may receive the at least one required SIB via the dedicated signaling from the BS 122 without switching to the downlink shared channel (DL-SCH). The data transmission and reception interruption may be prevented.

In one embodiment, the uplink message may be a reconfiguration complete message to the BS 122, where the reconfiguration complete message is transmitted in an event that a handover is performed after the handover command from the BS 121 is issued. In some cases, the dedicated signaling may be a radio resource control (RRC) reconfiguration message, and the UE 110 may transmit an RRC reconfiguration complete message to the BS 122. In some cases, the uplink message may be an RRC dedicated system information request. In some cases, the uplink message may be a user equipment (UE) assistance information. In some cases, the dedicated signaling may be an RRC dedicated system information.

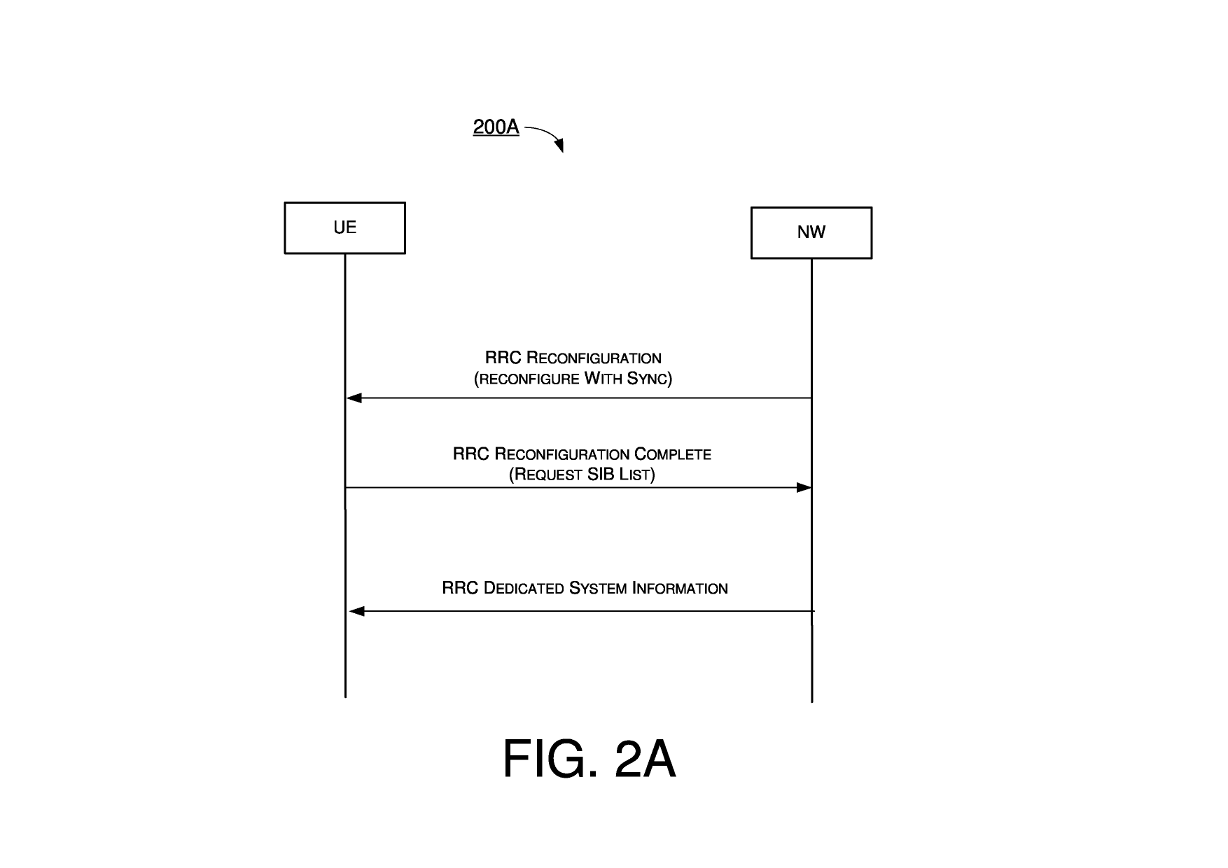

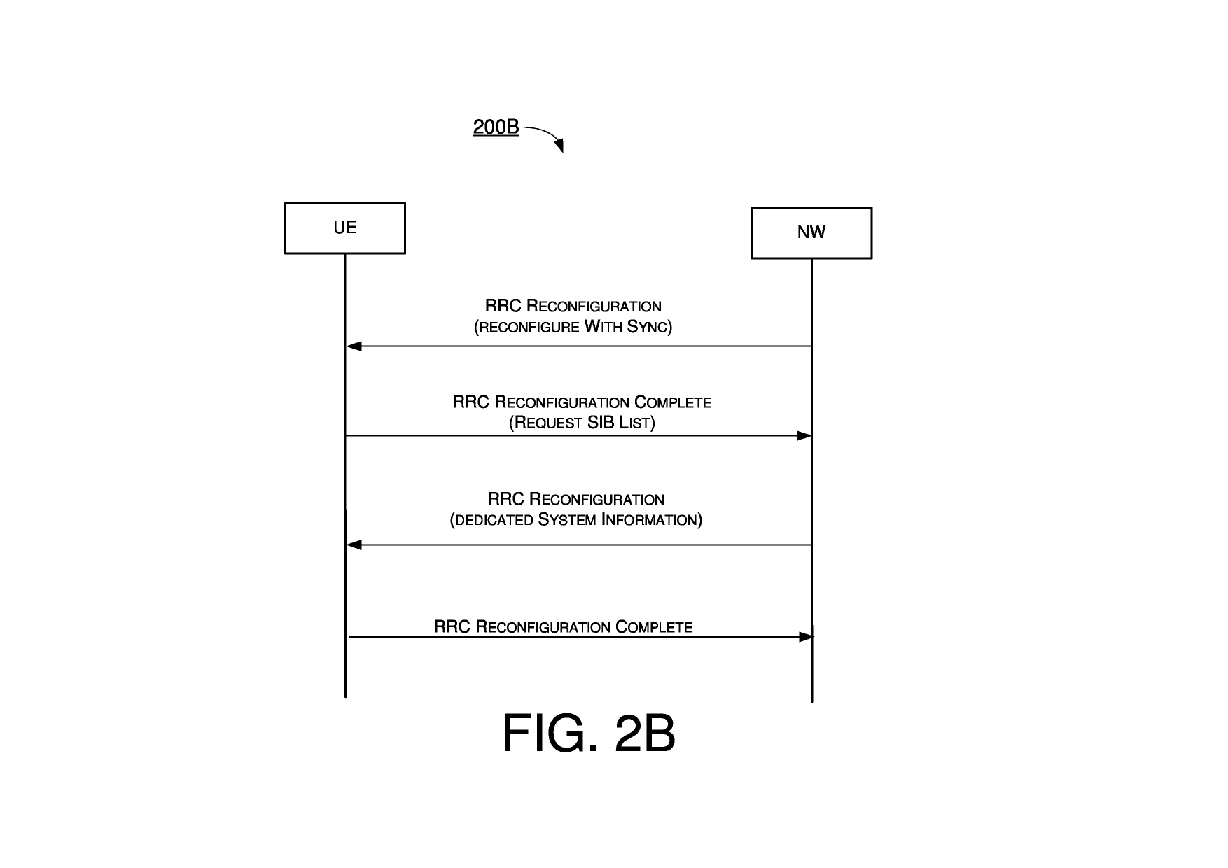

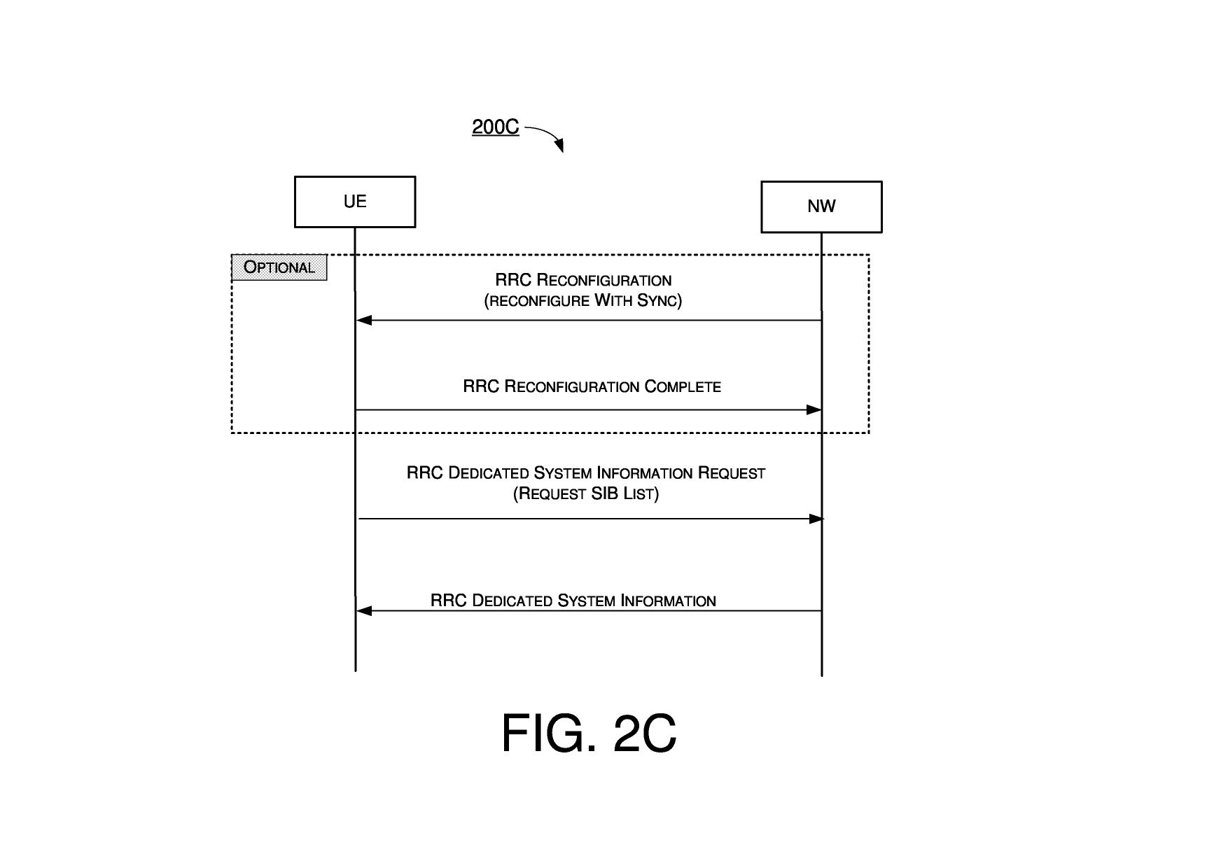

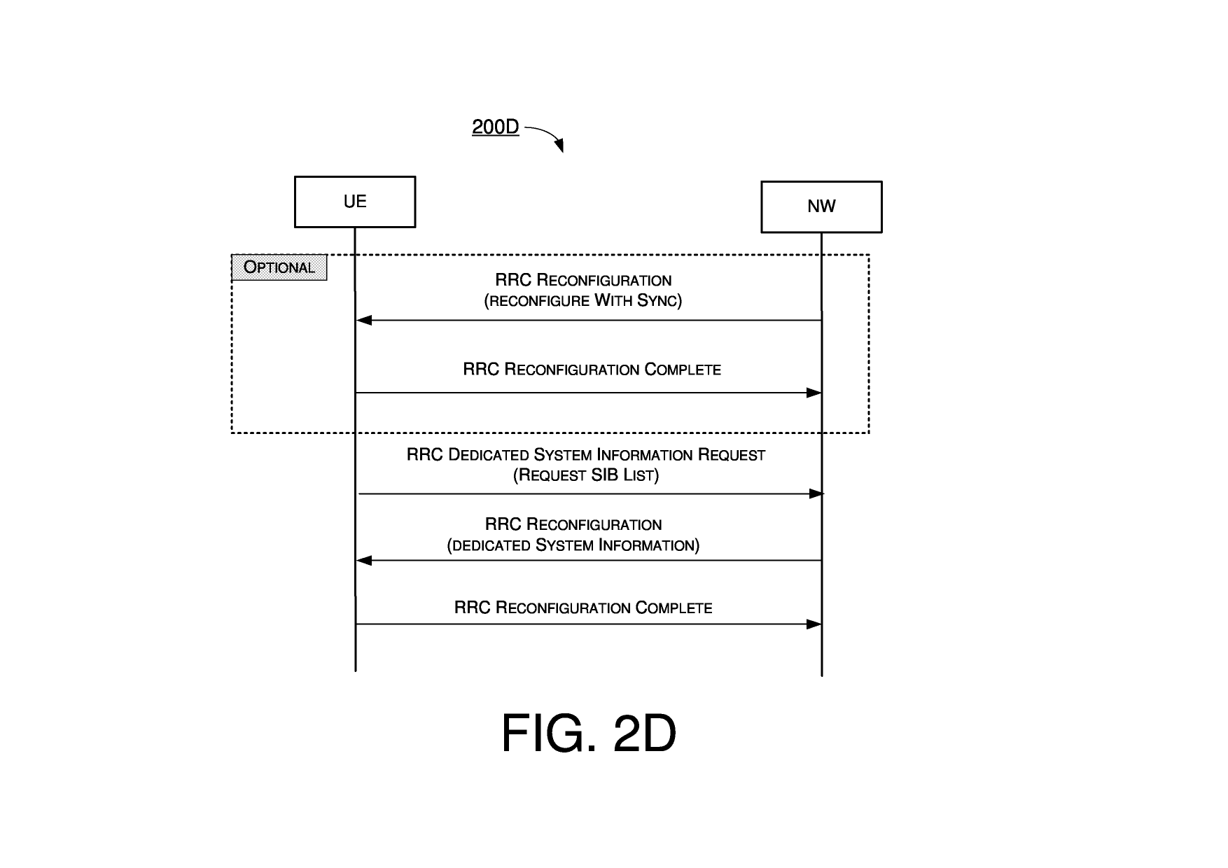

FIG. 2A to 2D are diagrams depicting example scenarios under schemes in accordance with implementations of the present disclosure, illustrating various message flows for acquiring system information via dedicated signaling. In particular, these figures demonstrate alternative signaling procedures for a User Equipment (UE) to obtain a list of the required System Information Block (SIB) from a Network (NW) while in a connected mode. The illustrated scenarios differ in the specific uplink message used to carry the request for the SIB list. For example, the request may be embedded within a handover completion message or transmitted as a standalone request. The scenarios also differ in the specific downlink message used to deliver the requested system information, which may be sent via dedicated signaling or encapsulated within an RRC reconfiguration message.

In scenario 200A, upon receiving an RRC reconfiguration message indicating a reconfiguration with sync (e.g., Reconfigure With Sync) from the network (NW), the UE transmits an RRC reconfiguration complete message to the NW. Specifically, to avoid service interruption, the UE determines the required SIBs and includes a request for a list of the required SIBs (e.g., Request SIB List) within the RRC reconfiguration complete message serving as the uplink message. Upon receiving the RRC reconfiguration complete message including the request, the NW transmits RRC dedicated system Information to the UE via dedicated signaling. This allows the UE to obtain the required SIBs without monitoring the broadcast channel.

In scenario 200B, the dedicated signaling for providing system information is implemented through an RRC reconfiguration message. Upon receiving the initial RRC reconfiguration (e.g., Reconfigure With Sync) from the NW, the UE transmits an RRC reconfiguration complete message including the request for the list of the required SIB(s) to the NW. Unlike scenario 200A, the NW responds by transmitting an RRC reconfiguration message including the dedicated system information. Upon receiving this dedicated signaling, the UE updates its configuration and transmits an RRC reconfiguration complete message back to the NW.

In scenario 200C, the uplink message for requesting SIBs is a separate RRC dedicated system information request. The UE first completes the handover by exchanging the RRC reconfiguration (e.g., Reconfigure With Sync) and RRC reconfiguration complete messages with the NW. Subsequently, upon determining that specific SIBs are required, the UE transmits an RRC dedicated system information request message indicating the list of the required SIB(s) (e.g., Request SIB List) to the NW. Upon receiving the request, the NW transmits the RRC dedicated system information via dedicated signaling to the UE, enabling the UE to acquire the information while remaining in a connected mode.

In scenario 200D, the scheme utilizes a separate request message and an RRC Reconfiguration response. After the initial handover signaling (RRC Reconfigure With Sync and RRC Reconfiguration Complete), the UE transmits an RRC dedicated system information request message including the request for the list of the required SIB(s) to the NW. In response to this uplink message, the NW transmits an RRC Reconfiguration message including the dedicated system information to the UE. Finally, upon receiving the RRC reconfiguration message, the UE transmits an RRC reconfiguration complete message to the NW.

### Illustrative Implementations

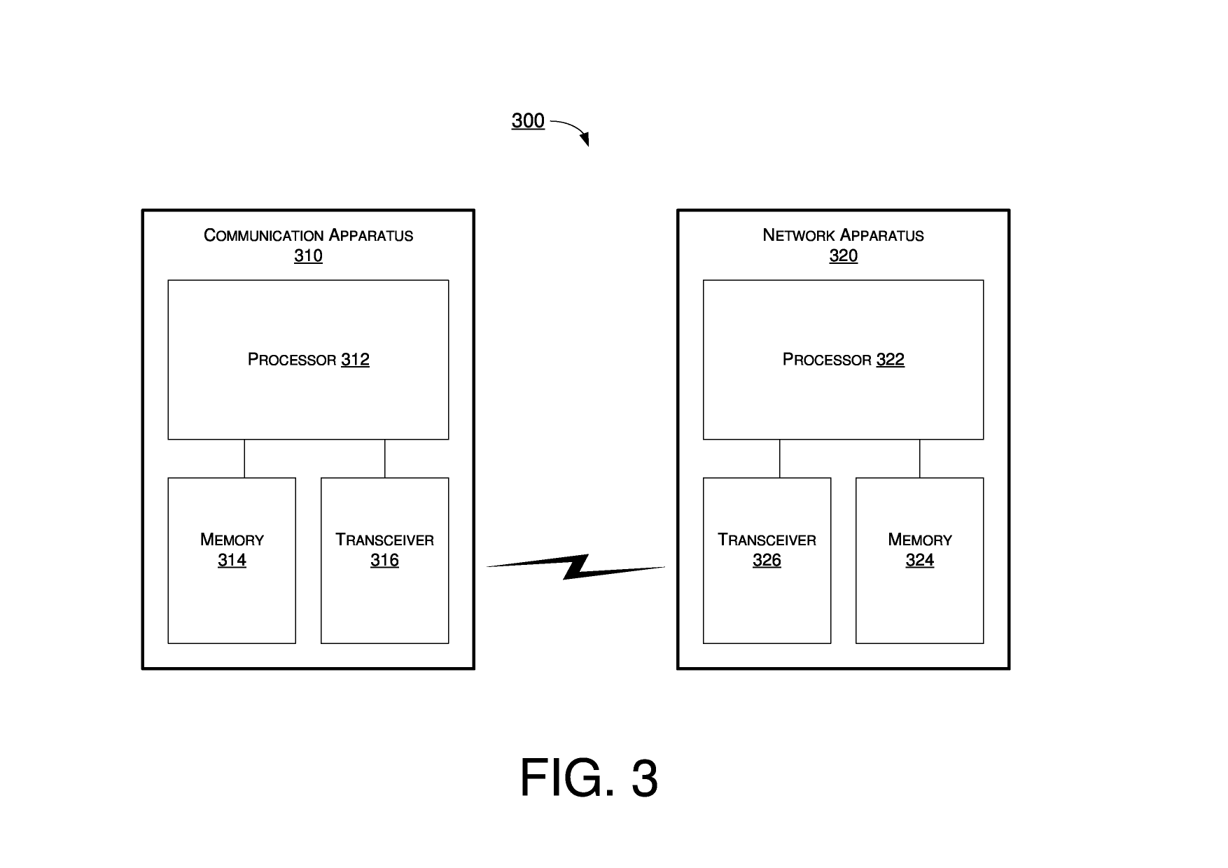

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to system information reception in a connected mode in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus, or a computing apparatus. For instance, communication apparatus 310 may be implemented in a smartphone, a smartwatch, a personal digital assistant, a digital camera, or a computing equipment such as a tablet computer, a laptop computer, or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310may be implemented in the form of one or more integrated-circuit (IC) chips, such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3, such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router, a gateway, or other network element. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including system information reception in a connected mode in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

### Illustrative Processes

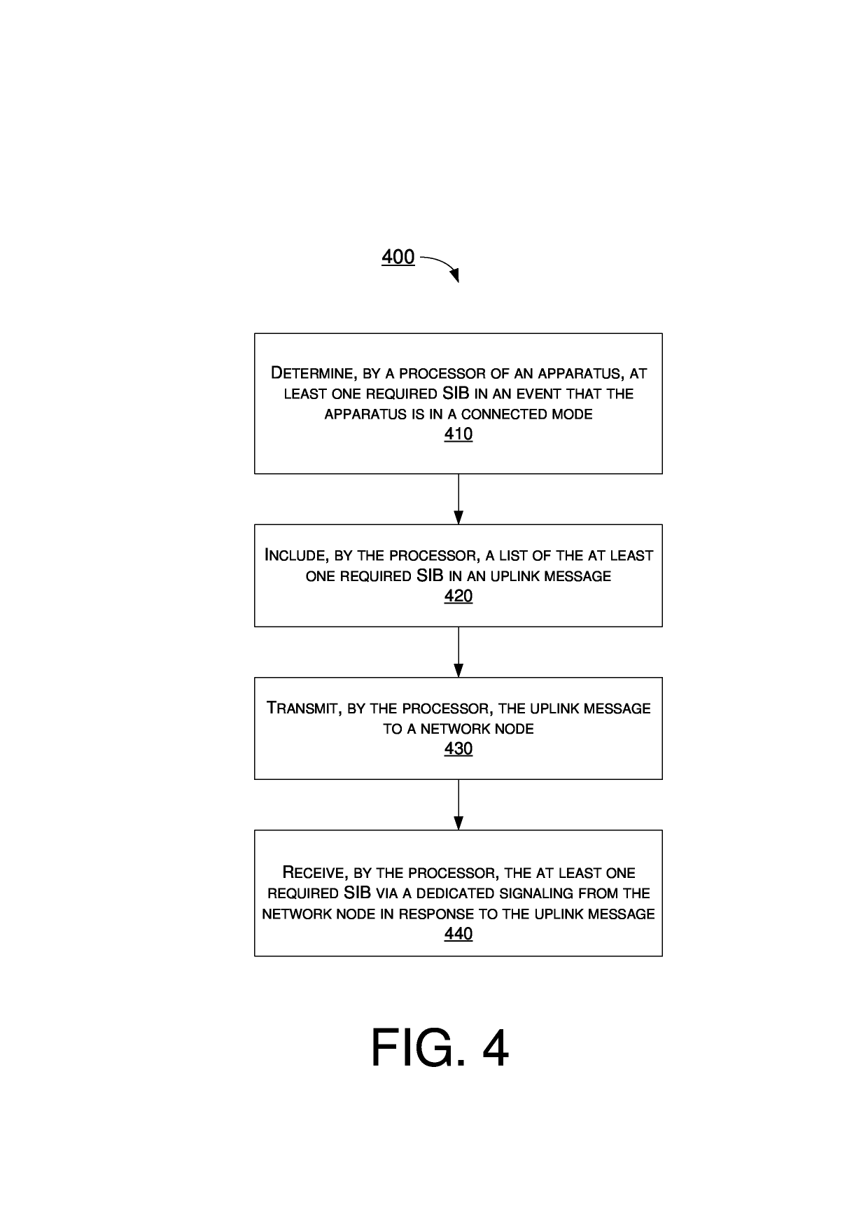

FIG. 4 is an example process 400 in accordance with an implementation of the present disclosure. Process 400 may be an example implementation of above scenarios/schemes, whether partially or completely, with respect to system information reception in a connected mode of the present disclosure. Process 400 may represent an aspect of implementation of features of communication apparatus 310. Process 400 may include one or more operations, actions, or functions as illustrated by one or more of blocks 410 to 440. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At block 410, process 400 may involve processor 312 of communication apparatus 310 determining at least one required system information block (SIB) in an event that the communication apparatus 310 is in a connected mode. Process 400 may proceed from block 410 to block 420.

At block 420, process 400 may involve processor 312 of communication apparatus 310 including a list of the at least one required SIB in an uplink message. Process 400 may proceed from block 420 to block 430.

At block 430, process 400 may involve processor 312 of communication apparatus 310 transmitting, via transceiver 316, the uplink message to a network node (e.g., network apparatus 320). Process 400 may proceed from block 430 to block 440.

At block 440, process 400 may involve processor 312 of communication apparatus 310 receiving, via transceiver 316, the at least one required SIB via a dedicated signaling from the network node in response to the uplink message. Upon reception, the processor 312 may apply the configuration parameters contained in the received SIB to update the operation of the communication apparatus 310.

In some implementations, the uplink message may include a reconfiguration complete message. And the reconfiguration complete message is transmitted in an event that a handover is performed.

In some implementations, the dedicated signaling may include a radio resource control (RRC) reconfiguration message, and process 400 may involve processor 312 of communication apparatus 310 transmitting an RRC reconfiguration complete message to the network node (e.g., network apparatus 320).

In some implementations, the uplink message may include a radio resource control (RRC) dedicated system information request.

In some implementations, the uplink message may include a user equipment (UE) assistance information.

In some implementations, the dedicated signaling may include a radio resource control (RRC) dedicated system information.

In some implementations, the receiving of the at least one required SIB is performed without switching to a downlink shared channel (DL-SCH).

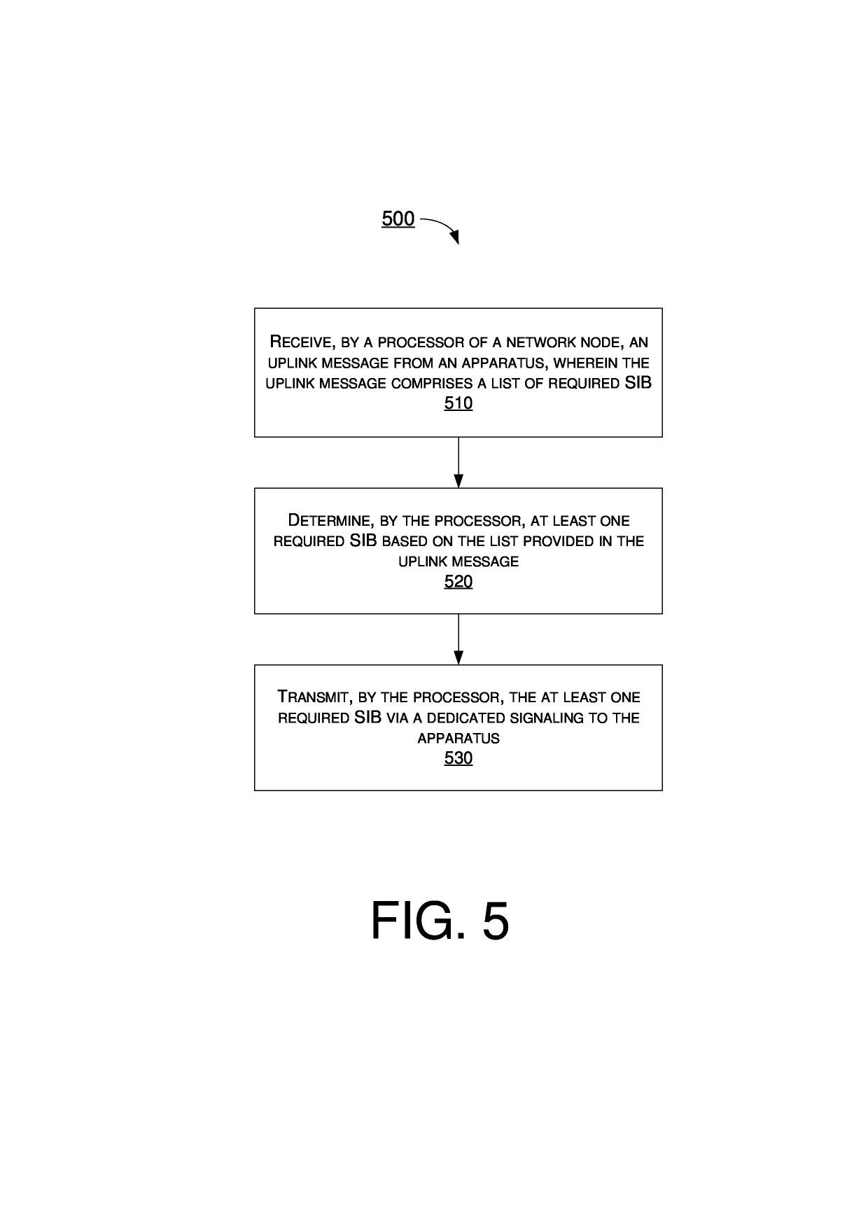

FIG. 5 is an example process 500 in accordance with an implementation of the present disclosure. Process 500 may be an example implementation of above scenarios/schemes, whether partially or completely, with respect to system information reception in a connected mode in mobile communications. Process 500 may represent an aspect of implementation of features of network apparatus 320. Process 500 may include one or more operations, actions, or functions as illustrated by one or more of blocks 510 to 540. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any base stations or network nodes. Solely for illustrative purposes and without limitation, process 500 is described below in the context of network apparatus 320. Process 500 may begin at block 510.

At block 510, process 500 may involve processor 322 of network apparatus 320 receiving, by a processor of a network node, an uplink message from an apparatus (e.g., communication apparatus 310). The uplink message may include a list of required system information block (SIB). Process 500 may proceed from block 510 to block 520.

At block 520, process 500 may involve processor 322 of network apparatus 320 determining at least one required SIB based on the list provided in the uplink message. The processor 322 may perform a verification to confirm that the requested SIBs are applicable to the current serving cell corresponding to the communication apparatus 310. Subsequently, the process 500 may assemble the content of the at least one required SIBs. Process 500 may proceed from block 520 to block 530.

At block 530, process 500 may involve processor 322 of network apparatus 320 transmitting, via transceiver 326, the at least one required SIB via a dedicated signaling to the apparatus (e.g., communication apparatus 310). Unlike broadcasting system information over a DL-SCH, transmitting the at least one required SIB via dedicated signaling allows the network node to utilize a specific resource to deliver the information directly to the communication apparatus 310. The process 500 reduces the acquisition time for the required SIB(s) of the communication apparatus 310.

In some implementations, process 500 may involve processor 322 of network apparatus 320 transmitting a handover command to the apparatus, wherein the uplink message comprises a reconfiguration complete message.

In some implementations, the dedicated signaling may include a radio resource control (RRC) reconfiguration message, and process 500 may involve processor 322 of network apparatus 320 receiving, via transceiver 326, a reconfiguration complete message from the apparatus.

In some implementations, the uplink message may include a radio resource control (RRC) dedicated system information request.

In some implementations, the uplink message may include a user equipment (UE) assistance information.

In some implementations, the dedicated signaling may include a radio resource control (RRC) dedicated system information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, at least one required system information block (SIB) in an event that the apparatus is in a connected mode;
including, by the processor, a list of the at least one required SIB in an uplink message;
transmitting, by the processor, the uplink message to a network node; and
receiving, by the processor, the at least one required SIB via a dedicated signaling from the network node in response to the uplink message.

2. The method of claim 1, wherein the uplink message comprises a reconfiguration complete message, and wherein the reconfiguration complete message is transmitted in an event that a handover is performed.

3. The method of claim 1, wherein the dedicated signaling comprises a radio resource control (RRC) reconfiguration message, and wherein the method further comprises:
transmitting, by the processor, an RRC reconfiguration complete message to the network node.

4. The method of claim 1, wherein the uplink message comprises a radio resource control (RRC) dedicated system information request.

5. The method of claim 1, wherein the uplink message comprises a user equipment (UE) assistance information.

6. The method of claim 1, wherein the dedicated signaling comprises a radio resource control (RRC) dedicated system information.

7. The method of claim 1, wherein the receiving of the at least one required SIB is performed without switching to a downlink shared channel (DL-SCH).

8. A method, comprising:
receiving, by a processor of a network node, an uplink message from an apparatus, wherein the uplink message comprises a list of required system information block (SIB);
determining, by the processor, at least one required SIB based on the list provided in the uplink message; and
transmitting, by the processor, the at least one required SIB via a dedicated signaling to the apparatus.

9. The method of claim 8, further comprising:
transmitting, by the processor, a handover command to the apparatus,
wherein the uplink message comprises a reconfiguration complete message.

10. The method of claim 8, wherein the dedicated signaling comprises a radio resource control (RRC) reconfiguration message, and wherein the method further comprises:
receiving, by the processor, a reconfiguration complete message from the apparatus.

11. The method of claim 8, wherein the uplink message comprises a radio resource control (RRC) dedicated system information request.

12. The method of claim 8, wherein the uplink message comprises a user equipment (UE) assistance information.

13. The method of claim 8, wherein the dedicated signaling comprises a radio resource control (RRC) dedicated system information.

14. An apparatus, comprising:
a transceiver which, during operation, communicates wirelessly; and
a processor communicatively coupled to the transceiver such that, during operation, the processor performs operations comprising:
determining at least one required system information block (SIB) in an event that the apparatus is in connected mode;
including a list of the at least one required SIB in an uplink message;
transmitting, via the transceiver, the uplink message to a network node; and
receiving, via the transceiver, the at least one required SIB via a dedicated signaling from the network node in response to the uplink message.

15. The apparatus of claim 14, wherein the uplink message comprises a reconfiguration complete message, and wherein the reconfiguration complete message is transmitted in an event that a handover is performed.

16. The apparatus of claim 14, wherein the dedicated signaling comprises a radio resource control (RRC) reconfiguration message, and wherein the processor further performs operations comprising:
transmitting, via the transceiver, a reconfiguration complete message to the network node.

17. The apparatus of claim 14, wherein the uplink message comprises a radio resource control (RRC) dedicated system information request.

18. The apparatus of claim 14, wherein the uplink message comprises a user equipment (UE) assistance information.

19. The apparatus of claim 14, wherein the dedicated signaling comprises a radio resource control (RRC) dedicated system information.

20. The apparatus of claim 14, wherein the receiving of the at least one required SIB is performed without switching to a downlink shared channel (DL-SCH).
